(19) United States
(12) Patent Application Publication
(10) Pub. No.: US 2013/0118450 A1
(43) Pub. Date: May 16, 2013

(54) VARIABLE INTAKE SYSTEM FOR VEHICLE

(71) Applicant: Sang Il LEE, Suwon-si (KR)

(72) Inventor: Sang Il LEE, Suwon-si (KR)

(73) Assignees: Kia Motors Corporation, Seoul (KR); Hyundai Motor Company, Seoul (KR)

(21) Appl. No.: 13/536,736

(22) Filed: Jun. 28, 2012

(30) Foreign Application Priority Data
Nov. 10, 2011 (KR) 10-2011-0117204

(51) Int. Cl. F02D 9/08; F02M 35/108

(52) U.S. Cl. 123/337; 123/184.56

(57) ABSTRACT

A variable intake system for a vehicle which controls air flow amount flowing into each combustion chamber according to rotation speed of an engine may include an air cleaner main body connected with a main duct and an auxiliary duct through which air flows, a valve housing which may be disposed within the air cleaner main body and communicated with the auxiliary duct, a valve assembly disposed to the valve housing and controlling an opening amount of the valve housing, an actuator mounted to the valve housing and coupled to the valve assembly to operate the valve assembly, and a controller controlling operation of the actuator, wherein the actuator may be a linear motor including a motor shaft which realizes linear motion according to supplying current to a coil of the actuator.

### CROSS-REFERENCE TO RELATED APPLICATION

The present application claims priority to Korean Patent Application No. 10-2011-0117204 filed in the Korean Intellectual Property Office on Nov. 10, 2011, the entire contents of which is incorporated herein for all purposes by this reference.

### BACKGROUND OF THE INVENTION

1. Field of the Invention

The present invention relates to a variable intake system for a vehicle. More particularly, the present invention relates to a variable intake system for a vehicle which may control air flow amount into a combustion chamber according to rotation speed of an engine.

2. Description of Related Art

Generally, an intake system provided to an engine for a vehicle purifies air flowing through an intake duct by means of a filter element within an air cleaner box and a plurality of intake duct is provided thereto for compensating air amount required in high speed and high load.

In a conventional art of a variable intake system, the intake ducts are ramified to be communicated respectively with an air cleaner housing. And thus one intake duct is opened in low speed and low load of an engine and the other intake duct are opened in high speed and high load of an engine.

The variable intake system may be provided with a valve assembly which may selectively open one intake duct and an actuator driving the valve assembly. And the actuator may be classified into a semi-active actuator type and an active actuator type.

The semi-active actuator type may be classified into a vacuum type actuator using a solenoid and an actuator using a magnet, and the active actuator type may use a DC motor.

In a conventional art, the semi-active actuator type may be difficult to control opening amount of the intake duct, and may not open completely in maximum RPM of an engine so as to increase intake-pressure and decrease maximum output of an engine. And also, linear characteristic of accelerating booming may be deteriorated, and responsiveness may be retarded.

Also, in a conventional art, the active actuator type is provided with an expensive DC motor and an element transferring power which is complex in structure. And also, caulking portion thereof may make noise, and rapid and exact control is difficult.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a variable intake system for a vehicle which may control air flow amount into a combustion chamber according to rotation speed of an engine, enhance linear characteristic of accelerating booming, reduce intake pressure and noise, improve engine performance, reduce manufacturing cost, and enhance control characteristic.

In an aspect of the present invention, a variable intake system for a vehicle which controls air flow amount flowing into each combustion chamber according to rotation speed of an engine, may include an air cleaner main body connected with a main duct and an auxiliary duct through which air flows, a valve housing which is disposed within the air cleaner main body and communicated with the auxiliary duct, a valve assembly disposed to the valve housing and controlling an opening amount of the valve housing, an actuator mounted to the valve housing and coupled to the valve assembly to operate the valve assembly, and a controller controlling operation of the actuator, wherein the actuator is a linear motor including a motor shaft which realizes linear motion according to supplying current to a coil of the actuator.

The variable intake system may further include a power delivery unit which couples the motor shaft of the linear motor and the valve assembly and converts the linear motion of the motor shaft to rotary motion.

The valve assembly may include a valve shaft rotatably mounted to the valve housing, and a flap fixed to the valve shaft and selectively opening the valve housing according to operation of the actuator.

The power delivery unit may include a first link member rotatably coupled to the motor shaft through a ball joint, a second link member rotatably coupled to the first link member, and a third link member fixed to the valve shaft and rotatably coupled to the second link member.

The linear motor may include a motor housing in which the motor shaft is protudedly disposed, a magnet which is disposed within the motor housing and encloses a guide member therein, wherein the motor shaft is movably disposed through the guide member and wherein the coil encloses the magnet, a support plate which is connected to an end portion of the motor shaft and supports the linear motion of the motor shaft within the motor housing, and an elastic member which is disposed between an interior surface of the motor housing and the support plate and elastically biases the support plate.

The controller determines an opening amount of the auxiliary duct according to a driving condition of the engine, supplies the current corresponding to the opening amount of the auxiliary duct to the actuator, and drives the valve assembly by means of the actuator so as to control the opening amount of the valve housing.

The variable intake system may further include a pressure sensor which is mounted to the air cleaner main body, detects air intake pressure in the air cleaner main body, and outputs detection signal to the controller.

The controller determines required inflow amount air through the auxiliary duct according to the air intake pressure in the air cleaner main body detected by the pressure sensor, supplies the current corresponding to the required inflow amount air to the actuator, and drives the valve assembly by means of the actuator so as to control the opening amount of the valve housing.

The controller maintains constant intake pressure by feedback of the intake pressure of the air cleaner main body regardless of driving conditions.

Since the variable intake system according to an exemplary embodiment of the present invention uses a linear motor such as a voice motor as an actuator driving a valve assembly and thus the variable intake system may realize enhance linear characteristic of accelerating booming and maintain intake pressure constantly comparing to a conventional semi-active type variable intake system. Also, the variable intake system according to an exemplary embodiment of the present invention may reduce noise and enhance engine output.

And the variable intake system according to an exemplary embodiment of the present invention may reduce manufacturing cost and noise and realize rapid and exact control comparing to a conventional active type variable intake system.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a drawing showing a variable intake system according to an exemplary embodiment of the present invention.

FIG. 2 is a partial perspective view showing a partial portion of a variable intake system according to an exemplary embodiment of the present invention.

FIG. 3 is a partially cut-away perspective view showing another partial portion of a variable intake system according to an exemplary embodiment of the present invention.

FIG. 4 is a partially cut-away perspective view of an actuator which is applied to a variable intake system according to an exemplary embodiment of the present invention.

FIG. 5 is a drawing showing a power delivery unit which is applied to a variable intake system according to an exemplary embodiment of the present invention.

FIG. 6 is a drawing showing a variable intake system according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Description of components that are not necessary for explaining the present invention will be omitted, and the same constituent elements are denoted by the same reference numerals in this specification.

In addition, size and thickness of components shown in the drawings may be differ from real size and real thickness of the components for better comprehension and ease of description. Therefore, the present invention is not limited to those shown in the drawings.

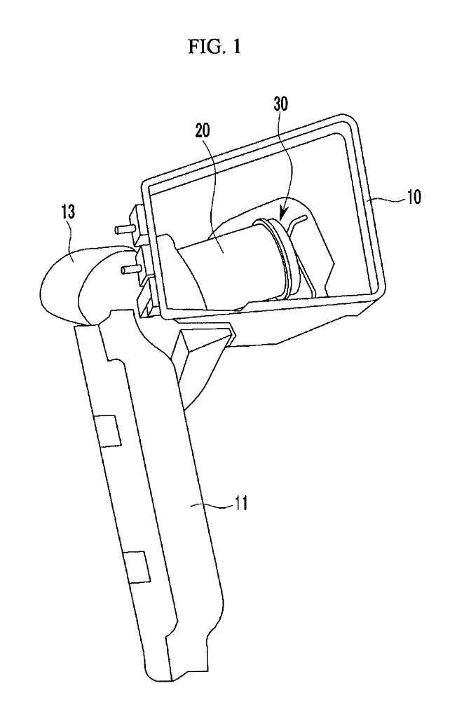

FIG. 1 is a drawing showing a variable intake system according to an exemplary embodiment of the present invention.

Referring to FIG. 1, a variable intake system 100 for a vehicle according to an exemplary embodiment of the present invention may be applied to an intake system which may supply air to each combustion chamber of an engine.

The variable intake system 100 includes a air cleaner purifying air supplied to the combustion chambers and may control air amount flowing into the combustion chambers according to rotation speed of the engine.

For example, the variable intake system 100 is provide with two ducts for the air flowing there through, and may supply the air using one duct in low/middle speed and may supply the air using two ducts in middle/high speed.

The variable intake system 100 according to an exemplary embodiment of the present invention may realize to enhance linear characteristic of accelerating booming and maintain intake pressure constantly comparing to a conventional semi-active type variable intake system.

Also, the variable intake system 100 according to an exemplary embodiment of the present invention may reduce manufacturing cost and noise and realize rapid and exact control comparing to a conventional active type variable intake system.

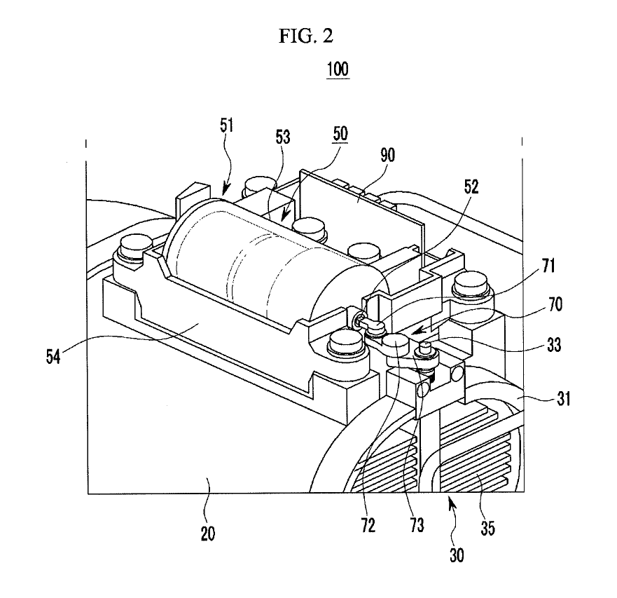

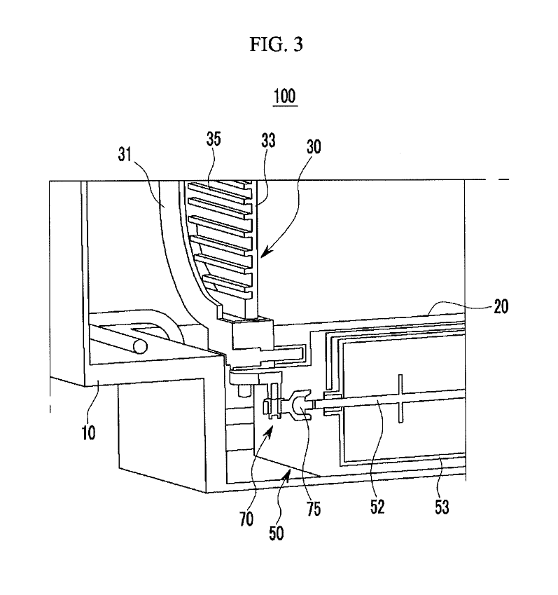

FIG. 2 is a partial perspective view showing a partial portion of a variable intake system according to an exemplary embodiment of the present invention, and FIG. 3 is a partially cut-away perspective view showing another partial portion of a variable intake system according to an exemplary embodiment of the present invention.

Referring to FIG. 1 to FIG. 3, the variable intake system 100 an exemplary embodiment of the present invention basically includes an air cleaner main body 10, a valve housing 20, a valve assembly 30, an actuator 50, a power delivery unit 70, and a controller 90, and each element will be described as follows.

In an exemplary embodiment of the present invention, the air cleaner main body 10 may purify air flowing into each combustion chamber of an engine and include a filter element (not shown in the drawings) eliminating foreign substance from the intake air.

The air cleaner main body 10 is provided with two intake portions flowing the air through and each intake portion is provided with a main duct 11 and an auxiliary duct 13 of which air may flow through.

The main duct 11 is used for inflowing the air supplied into the combustion chambers in low/middle engine speed, and the auxiliary duct 13 is used for inflowing the air supplied into the combustion chambers in middle/high engine speed together with the main duct 11.

And the air cleaner main body 10 is provided with an exhaust portion where the air flowing through the main duct 11 and/or the auxiliary duct 13 to supply into the combustion chambers.

The air cleaner main body 10 is obvious to a person skilled in the art and thus detailed description of the air cleaner main body 10 will be omitted in the specification.

In an exemplary embodiment of the present invention, the valve housing 20 is adapted to mount the valve assembly 30 and the actuator 50 and the valve housing 20 is disposed within the air cleaner main body 10 to be connected with the auxiliary duct 13.

The valve housing 20 is communicated with the auxiliary duct 13 and fixed in the air cleaner main body 10.

In an exemplary embodiment of the present invention, the valve assembly 30 is adapted to control opening amount of the valve housing 20 communicated with the auxiliary duct 13.

The valve assembly 30 is connected to an end of valve housing 20 and includes a valve frame 31, a valve shaft 33 and a flap 35.

The valve frame 31 may be shaped as a ring, and is connected to the end of the valve housing 20.

The valve shaft 33 is rotatably mounted to the valve frame 31 though a bush and a bush housing.

The valve shaft 33 may penetrate the valve frame 31 and may be protruded from the end of the valve housing 20.

The flap 35 closes or opens the valve housing 20, has a plate shape corresponding to the valve housing 20, and is connected to the valve shaft 33.

In an exemplary embodiment of the present invention, the actuator 50 is adapted to drive the valve shaft 33 of the valve assembly 30 and mounted an outer circumference of the valve housing 20.

The actuator 50 is a linear motor 51 such as a voice-coil motor.

In an exemplary embodiment of the present invention, the linear motor 51, according to Fleming's left hand rule, includes a motor shaft 52 which may move forward/rearward as linear motion according to current supplied to a coil.

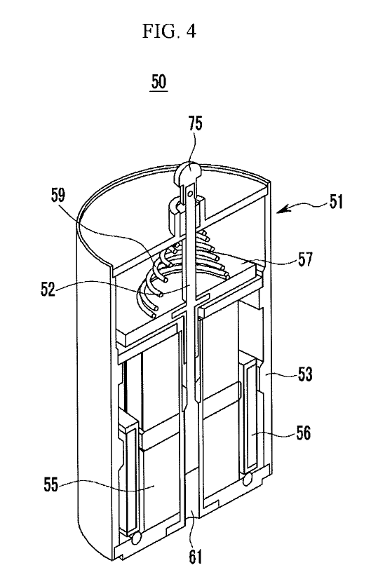

The linear motor 51, as shown in FIG. 4, includes a motor housing 53, a permanent magnet 55, a support plate 57, and an elastic member 59.

The motor housing 53 is mounted to an outer circumference of the valve housing 20 through a mounting bracket 54 and the motor shaft 52 is protruded therefrom.

The permanent magnet 55 is mounted within the motor housing 53, a coil 56 winds up the permanent magnet 55, and the motor shaft 52, guided by a guide member 61, is movably disposed thereto.

When current is supplied to the coil 56, the motor shaft 52 is protruded through the guide member 61 corresponding to the supplied current.

The support plate 57 is connected to the motor shaft 52 and moves together with the motor shaft 52 within the motor housing 53.

The elastic member 59 is disposed between an inner surface of the motor housing 53 and the support plate 57 and supplies elastic force to the support plate 57.

In the state that the current is supplied to the coil 56 so as that the motor shaft 52 is protruded, if the current is cut off, the motor shaft 52 returns to an original position by means of the elastic restoring force of the elastic member 59 applied to the support plate 57.

In an exemplary embodiment of the present invention, the power delivery unit 70 is adapted to connect the motor shaft 52 the valve shaft 33 of the valve assembly 30 and convert the linear motion of the linear motor 51 to rotary motion.

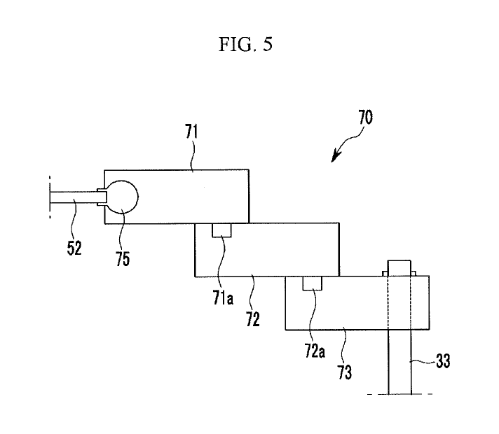

The power delivery unit 70 may be formed of a multi link structure, as shown in FIG. 5, and includes a first link member 71, a second link member 72 and a third link member 73.

The first link member 71 is rotatably connected to an end of the motor shaft 52 through a ball joint 75 connected to the end of the motor shaft 52.

The second link member 72 is rotatably connected to the first link member 71 though a first link rotation axis 71 a formed to the first link member 71.

And the third link member 73 is connected to a protruded end of the valve shaft 33 and is rotatably connected to the second link member 72.

In this case, the third link member 73 is rotatably connected to a second link rotation axis 72a formed to the second link member 72.

And thus, the first, second, and third link member 71, 72, and 73 rotates around the ball joint 75, the first link rotation axis 71a and the second link rotation axis 72a respectively according to forward or rearward movement of the motor shaft 52. So, the valve shaft 33 rotates according to the forward or rearward movement of the motor shaft 52, and thus the flap 35 opens or closes the valve housing 20.

In an exemplary embodiment of the present invention, the controller (90: referring to FIG. 2) is adapted to control total operation of the system and especially, to control the linear motor 51 of the actuator 50 according to the rotation speed of the engine.

That is, the controller 90 supplies electrical signal to the linear motor 51 to operate the valve assembly 30 to control opening amount of the auxiliary duct 13 in middle/high speed of the engine.

The controller 90, as control logic, calculates opening amount of the auxiliary duct 13 according to a driving condition of the engine, supplies the current corresponding to the opening amount of the auxiliary duct 13 to the linear motor 51, and drives the valve assembly 30 by means of the linear motor 51 so as to control the air inflowing amount through the auxiliary duct 13 and the valve housing 20.

Hereinafter, operation and control method of the variable intake system 100 according to an exemplary embodiment of the present invention will be described referring to the drawings.

In an exemplary embodiment of the present invention, the air flows into the combustion chambers through the main duct 11 in low/middle speed of the engine. In this case, the linear motor 51 of the actuator 50 is not operated by the control of the controller 90.

That is, the flap 35 of the valve assembly 30 closes the valve housing 20 communicated with the auxiliary duct 13.

Thus, in an exemplary embodiment of the present invention, the air flows into each combustion chamber through the main duct 11 in so that intake noise may be reduced, so a separated resonator for reducing intake noise may not be required.

The controller 90 according to an exemplary embodiment of the present invention calculates opening amount of the auxiliary duct 13 according to a driving condition of the engine and supplies the current corresponding to the opening amount of the auxiliary duct 13 to the actuator (the coil 56 of the linear motor 51) in middle/high speed.

Since the current is supplied to the coil 56 disposed within magnetic field of the permanent magnet 55 and thus the motor shaft 52 guided by the guide member 61 linearly moves corresponding to the current.

The motor shaft 52 of the linear motor 51 is protruded from the motor housing 53 according to the Fleming's left hand rule, and moves together with the support plate 57 so as to push the elastic member 59.

And thus the valve shaft 33 is rotated through the first to the third link member 71, 72, and 73 of the power delivery unit 70 by means of forward movement of the motor shaft 52.

Also, the flap 35 rotates with the valve shaft 33 so as to open the valve housing 20 communicated with the auxiliary duct 13.

And thus, in an exemplary embodiment of the present invention, the intake air may be supplied to each combustion chamber though the main duct 11 together with the auxiliary duct 13 in the middle/high speed.

So, in the middle/high speed, the engine output may be enhanced using both the main duct 11 and auxiliary duct 13.

If the engine operation condition is change from the middle/high speed to low/middle speed, the controller 90 cuts off the current supplied to the linear motor 51.

And then, the motor shaft 52 of the linear motor 51 returns to the original position by means of the elastic restoring force of the elastic member 59 to the support plate 57. So, the valve shaft 33 of the valve assembly 30 rotates and the flap 35 connected to the power delivery unit 70 closes the valve housing 20.

As described above, the variable intake system 100 according to an exemplary embodiment of the present invention uses the linear motor such as a voice-coil motor and thus may realize linearization of the accelerating booming and maintain the intake pressure in a predetermined value comparing to the conventional semi-active type. Also, the variable intake system 100 may reduce noise and improve engine output performance, and may reduce manufacturing cost and realize rapid and exact control comparing to the conventional active type.

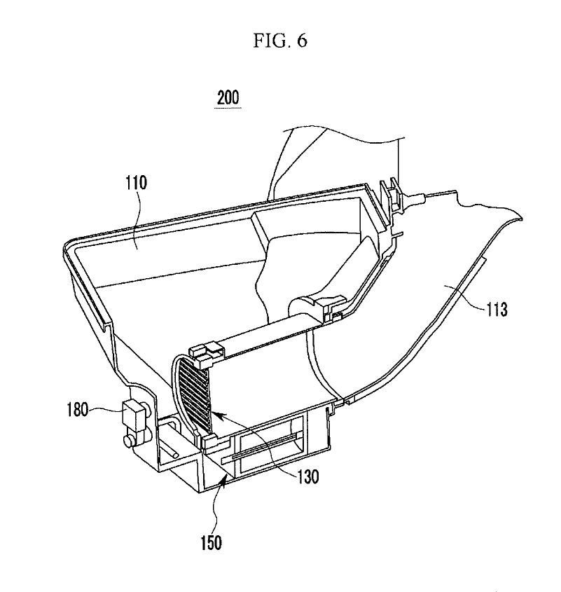

FIG. 6 is a drawing showing a variable intake system according to another exemplary embodiment of the present invention.

Referring to FIG. 6, a variable intake system 200 according to another exemplary embodiment of the present invention further includes a pressure sensor 180 which detects air intake pressure of an air cleaner main body 110 and outputs detection signal to the controller (referring to 90 in FIG. 2).

The pressure sensor 180 is called as “MAF sensor” in the related art, and is mounted to the air cleaner main body 110.

The controller 90 calculates required inflow amount air through an auxiliary duct 113 according to the air intake pressure in the air cleaner main body 110 detected by the pressure sensor 180, calculates opening angle of the flap 35, supplies the current corresponding to the required inflow amount air to an actuator 150, and drives a valve assembly 130 by means of the actuator 150 so as to control the opening amount of the valve housing.

And the controller 90 maintains constant intake pressure by feedback of the intake pressure of the air cleaner main body 110 regardless of driving conditions.

Other elements and operations of the variable intake system 200 for a vehicle according to another exemplary embodiment of the present invention is identical to the above described exemplary embodiment of the present invention, and thus repeated description will be omitted.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A variable intake system for a vehicle which controls air flow amount flowing into each combustion chamber according to rotation speed of an engine, the variable intake system comprising:
an air cleaner main body connected with a main duct and an auxiliary duct through which air flows;
a valve housing which is disposed within the air cleaner main body and communicated with the auxiliary duct;
a valve assembly disposed to the valve housing and controlling an opening amount of the valve housing;
an actuator mounted to the valve housing and coupled to the valve assembly to operate the valve assembly; and
a controller controlling operation of the actuator,
wherein the actuator is a linear motor including a motor shaft which realizes linear motion according to supplying current to a coil of the actuator.

2. The variable intake system of claim 1, wherein the variable intake system further includes a power delivery unit which couples the motor shaft of the linear motor and the valve assembly and converts the linear motion of the motor shaft to rotary motion.

3. The variable intake system of claim 2, wherein the valve assembly includes:
a valve shaft rotatably mounted to the valve housing; and
a flap fixed to the valve shaft and selectively opening the valve housing according to operation of the actuator.

4. The variable intake system of claim 3, wherein the power delivery unit includes:
a first link member rotatably coupled to the motor shaft through a ball joint;
a second link member rotatably coupled to the first link member; and
a third link member fixed to the valve shaft and rotatably coupled to the second link member.

5. The variable intake system of claim 1, wherein the linear motor includes:
a motor housing in which the motor shaft is protudedly disposed;
a magnet which is disposed within the motor housing and encloses a guide member therein, wherein the motor shaft is movably disposed through the guide member and wherein the coil encloses the magnet;
a support plate which is connected to an end portion of the motor shaft and supports the linear motion of the motor shaft within the motor housing; and
an elastic member which is disposed between an interior surface of the motor housing and the support plate and elastically biases the support plate.

6. The variable intake system of claim 1, wherein the controller determines an opening amount of the auxiliary duct according to a driving condition of the engine, supplies the current corresponding to the opening amount of the auxiliary duct to the actuator, and drives the valve assembly by means of the actuator so as to control the opening amount of the valve housing.

7. The variable intake system of claim 1, wherein the variable intake system further includes a pressure sensor which is mounted to the air cleaner main body, detects air intake pressure in the air cleaner main body, and outputs detection signal to the controller.

8. The variable intake system of claim 7, wherein the controller determines required inflow amount air through the auxiliary duct according to the air intake pressure in the air cleaner main body detected by the pressure sensor, supplies the current corresponding to the required inflow amount air to the actuator, and drives the valve assembly by means of the actuator so as to control the opening amount of the valve housing.

9. The variable intake system of claim 8, wherein the controller maintains constant intake pressure by feedback of the intake pressure of the air cleaner main body regardless of driving conditions.
